(19) United States
(12) Patent Application Publication
(10) Pub. No.: US 2010/0317766 A1
(43) Pub. Date: Dec. 16, 2010

(54) Optical Composite Material And Optical Device Using the Same

(76) Inventor: Hiroaki Ando, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/864,379

(22) PCT Filed: Jan. 19, 2009
(86) PCT No.: PCT/JP2009/050650

§ 371 Date: Jul. 23, 2010

(30) Foreign Application Priority Data
Jan. 29, 2008 (JP) 2008-017397

(51) Int. Cl. C08K 7/00

(52) U.S. Cl. 523/205

(57) ABSTRACT

An optical composite material which exhibits high transparency, can make use of the superior optical characteristics of an inorganic material and is specifically applicable to the use required for heat resistance is disclosed, comprising a curable resin compound and inorganic particles having a volume average diameter of not less than 3.0 nm and not more than 15 nm and having been treated with a surface treatment agent exhibiting an average refractive index of not less than 1.50 and not more than 1.70, and the composite material exhibiting a cross-linking density of not less than 0.50 mmol/cm³ and not more than 7.0 mmol/cm³. An optical device by use thereof is also disclosed.

### TECHNICAL FIELD

The present invention relates to an optical composite material by use of nanoparticles having been subjected to a novel surface treatment and an optical device by use the same which is suitable for a lens, a filter, a grating, an optical fiber, an optical slab-waveguide and the like.

### TECHNICAL BACKGROUND

Recently, there have been actively made studies of composite materials nanoparticles and a resin. Specifically, reduction of the particle size of nanoparticles and enhancement of their dispersibility in a resin result in enhanced transparency of a composite material, making application thereof to optical devices feasible. Most of inorganic materials for use in optical devices, for example, a glass material or the like, exhibit characteristics such as a high refractive index and a low linear expansion coefficient, which are deficient in a resin, while low machinability restricts applicable uses thereof. Accordingly, there was made an attempt of improving machinability by composition with a resin to take advantage of the superior optical characteristic of an inorganic material (as described in, for example, patent document 1).

Specifically, the use of an inorganic material with a high refractive index makes it feasible to achieve an enhanced refractive index thereof leading to a merit; however, a surface treatment of particles is indispensable to attain affinity to a resin. Various kinds of coupling agents are known as a surface treatment agent for particles but there are few reports referring to the refractive index of a coupling agent. It is supposed to use a resin containing a hydroxyl or carboxylic acid group as a means to disperse a high-polar particles in a resin; however, most of such resins exhibit a high hygroscopic property and hygroscopicity as a composite is also high, leading to a disadvantage of humidity dependence of physical properties, specifically, refractive index becoming increased. Finally, it becomes difficult to contain a large number of polar groups within the resin itself, so that it becomes necessary to inhibit an increase oflight scattering along with particle coagulation and a lowering of transmittance by hydrophobilization of the particle surface to achieve enhanced dispersibility in a low-polar resin.

On the other hand, the cross-linking density of a composite is largely related to its heat resistance. Specifically, it is supposed that a higher cross-linking density results in reduced linear expansion, leading to enhanced heat resistance.

There have been known individual tendencies but it has not been proposed that it is necessary to simultaneously satisfy these characteristics.

Patent document 1: JP 2005-316219A.

### DISCLOSURE OF THE INVENTION

### Problems to be Solved in the Invention

The present invention has come into being in view of the foregoing problems. It is an object of the present invention to provide an optical composite material which exhibits high transparency, can make use of the superior optical characteristics of an inorganic material and is specifically applicable to the use required for heat resistance, and an optical device by use of the same.

### Means for Solving the Problems

The foregoing object of the present invention can be realized by the following constitution.

1. An optical composite material comprising a curable resin compound and inorganic particles having a volume average diameter of not less than 3.0 nm and not more than 15 nm and having been treated with a surface treatment agent exhibiting an average refractive index of not less than 1.50 and not more than 1.70, and the composite material exhibiting a cross-linking density of not less than 0.50 mmol/cm³ and not more than 7.0 mmol/cm³.

2. The optical composite material, as described in the foregoing 1, wherein the composite material exhibits a saturated water absorption amount of not more than 3.5% by mass at a temperature of 70° C. and at a relative humidity of 80%.

3. The optical composite material, as described in the foregoing 1 or 2, wherein the inorganic particles exhibit a refractive index of not less than 1.50 and not more than 2.80.

4. An optical device by use of an optical composite material, as described in any of the foregoing 1 to 3.

5. The optical composite material, as described in the foregoing 1., wherein the surface treatment agent contains an adamantyl group.

6. The optical composite material, as described in the foregoing 1., wherein the curable resin compound contains an adamantyl group.

### Effect of the Invention

According to the invention, there was provided an optical composite material, exhibiting high transparency, making use of superior optical characteristics of an inorganic material and specifically applicable when heat resistance is required, and an optical device by use of the same.

### BRIEF DESCRIPTION OF THE DRAWING

FIG. 1 shows a schematic sectional view showing an example of an optical device (plastic lens) related to the preferred embodiments of the present invention.

### DESCRIPTION OF DESIGNATIONS

1: Optical device

2: Laser oscillator

3: Collimator

4: Beam splitter

5: ¼ wavelength plate

6. Diaphragm

7: Objective lens (optical device)

8: Sensor lens group

9: Sensor

10: Two-dimensional actuator

D: Optical disc

D1: Protective substrate

D2: Information recording face

### PREFERRED EMBODIMENTS OF THE INVENTION

There will be sequentially described constituent features of the optical composite material of the present invention.

### Inorganic Particles

Inorganic particles relating to the invention include various kinds of inorganic particles. The average particle diameter of the inorganic particles is not less than 3 nm and not more than 15 nm in terms of volume average diameter. When the average particle diametere is less than 3 nm, there is a concern such that dispersing particles becomes difficult, making it difficult to achieve desired performance, so that the average particle size is preferably not less than 3 nm. On the other hand, when the average particle diameter is more than 15 nm, there is a concern such that an optical composite material obtained by difference in refractive index becomes turbid, leading to a lowering of transparency. Herein, “volume average particle diameter” refers to a volume average value of diameters when the individual particles are converted to a sphere having the same volume (sphere equivalent diameters). Specific examples of a measurement method include a dynamic light scattering method, a laser diffraction method, a centrifugal sedimentation method, a FFF method, an electrical detector method and the like, and the volume average particle diameter defined in the invention uses a value measured by Zetasizer, made by Malbern Instruments Co. (dynamic light scattering method).

Preferably, the inorganic particles employ various kinds of inorganic particles exhibiting a refractive index (at a wavelength of 588 nm) falling within the range of 1.50 to 2.80 (more preferably, 1.65 to 250). A high refractive index is advantageous for its use but a smaller particle size is needed to attain transparence and it is disadvantageous from the view point of water absorption as well as an increased load of being highly dispersed.

Specifically, there are preferably employed oxide particles, metal salt particles or semiconductor particles, of which it is preferred to optimally choose one not causing absorption, emission or fluorescence within the specific wavelength region used as an optical device.

Such oxide particles can employ a metal oxide of one or more metals selected from Li, Na, Mg, Al, K, Ca, Sc, Ti, V, Cr, Mn, Fe, Co, Ni, Cu, Zn, Rb, Sr, Y, Nb, Zr, Mo, Ag, Cd, Id, Sn, Sb, Cs, Ba, La, Ta, Hf, W, Ir, Tl, Pb, Bi and rare earth metals. Specifically, among particles of for example, titanium oxide, zinc oxide, aluminum oxide (alumina), zirconium oxide, hafnium oxide, niobium oxide, tantalum oxide, magnesium oxide, barium oxide, indium oxide, tin oxide, lead oxide and double oxides composed of these oxides, such as lithium niobate, potassium niobate, lithium tantalate and aluminum magnesium oxide (MgAl₂O₄) are cited ones exhibiting a refractive index of 1.50 to 2.80.

Further, oxide particles can employ rare earth oxides and specific examples thereof include scandium oxide, yttrium oxide, lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, and lutetium oxide.

Metal salt particles can employ a carbonate, phosphate or sulfate particles, or their composite particles which exhibit a refractive index falling within the range of 1.50 to 2.80. Further, an oxo-cluster Ti or Zr is also applicable.

Inorganic particles can be prepared by spraying a raw material of the inorganic particles, followed by calcination in a gas phase to obtain minute particles. There can also be suitably employed a method of preparing inorganic particles by using a plasma, a method of allowing a solid raw material to be ablated by a laser or the like, or a method of oxidizing vaporized metal gas to form inorganic particles. Further, a method of preparation in a liquid phase is also feasible, in which a dispersion of inorganic particles dispersed as substantially primary particles can be prepared. It is also possible to obtain a dispersion of uniform-sized particles by use of a reaction crystallization method employing a lowering of solubility.

It is preferred to subject inorganic particles prepared in a liquid phase to drying and calcination to perform stable withdrawal of functions of the inorganic particles. A drying means such as freeze-drying, spray-drying or supercritical-drying is applicable and calcination is conducted preferably not only by performing heating with controlling the atmosphere but also by using an inorganic or organic anti-sintering agent.

It is preferred to employ diamond particles to achieve an enhancement of the refractive index. Diamond particles can be obtained by an explosion method, an impact compression method or a static pressure method, and those obtained by an explosion method or an impact compression method are preferred in terms of dispersibility. Diamond essentially has no polarity in its backbone and exhibits reduced hygroscopicity so that, when used for an optical composite material, it is preferred to use it in the state of hydrophilic functional groups easily formed on the surface being removed, whereby moisture resistance is provided.

Optical properties of inorganic particles are highly advantageous in a respect of being different in refractive index and its wavelength dispersion (of which the reciprocal is known as an Abbe's number) from an organic material. Namely, in an organic material, introduction of an aromatic ring enables enhancement of a refractive index but tends to result in abrupt reduction of the Abbe's number, introduction of a sulfur atom can depress a lowering of the Abbe's number to some extent but produces problems such as generation of odor or lowering of heat resistance. On the contrary, in the case of enhancement of refractive index by introduction of inorganic particles, it is feasible to select particles hardly causing a lowering of the Abbe's number and odor or a lowering of heat resistance rarely occurs. An optical material with a high refractive index and a high Abbe's number is valuable, for example, in such respect that, when applied to an imaging lens, a lens which has a great deal of potential in achromatism can be obtained.

In the invention, measurement of the refractive index of inorganic particles can employ techniques described in the literature. For instance, a Becke's line method which is described in quarterly published chemical review No. 39, “Tomei Polymer no Kussetsuritsi Seigyo” (Refractive Index Control of Transparent Polymer), pages 33-34, edited by Nippon Kagaku-kai, is applicable to measurement of the refractive index for particle-aggregated powder. There have been cases where a refractive index of inorganic particles was too high for direct determination thereof. In such a case, the refractive index of inorganic particles can be calculated backward by comparison of a refractive index of dispersion with that of an original dispersion medium. Namely, an average refractive index can be easily calculated by the following expression:

nₐᵥ≈Vₚ×nₚ+(1−Vₚ)×n_{dis}

where nₐᵥ is the average refractive index of dispersion, nₚ is the refractive index of inorganic particles, n_{dis} is the refractive index of a dispersion medium, and Vₚ is the volume fraction of inorganic particles in a dispersion. Of the foregoing, the most preferable method is determination from the measured value of an average refractive index of a particle dispersion, and the refractive index of inorganic particles, defined in the present invention is a value obtained in this method.

### Surface Treatment Agent of Average Refractive Index 1.50-1.70

The surface treatment agent in the present invention is featured in that it exhibits an average refractive index of not less than 1.50 and not more than 1.70. In the invention, a measurement means similar to the foregoing measurement of refractive index of inorganic particles is applicable to measurement of the refractive index of a surface treatment agent of the invention. In cases when a polymer can be fabricated to a thin film through heating or dissolution in a solvent, it is measurable down to three decimal places by application of a mode-line method. In cases when fabrication by heating or dissolution in a solvent is difficult, its refractive index can be determined by application of the Becke's line method using an immersion liquid of a known refractive index, while a polymer is in an irregular particle form.

In the invention, strictly speaking, a refractive index of a surface treatment agent in the state of being adsorbed onto the inorganic particle surface is an essential factor, which may be replaced by a refractive index of a surface treatment agent prior to being used. In cases when a polymer is grafted onto the particle surface, only particles after being grafted are dissolved to separate a grafted polymer and its refractive index is measured, whereby the refractive index of the graft polymer as a surface treatment agent can be determined. Alternatively, surface-treated particles and a resin are composited, from a refractive index of which the refractive index of a surface treatment agent can be calculated. Further, the refractive index of a surface treatment agent can be approximately calculated from a so-called Lorentz-Lorentz equation. To improve a refractive index, it is preferred to choose a surface treatment agent having a structure of a large molar refraction and a small molar volume. For example, it is preferred to contain a heteroatom such as S or N, a halogen such as Cl, Br, or I, except for F, a bond of C═C or C≡C or an aromatic ring, a quarternary carbon such as >C<, or the like. Designation of a surface treatment agent is feasible based on such knowledge. Some metal ions or complexes play a part in improvement of the refractive index so that it is preferred to make use thereof. The refractive index of a surface treatment agent, as defined in the invention is calculated by the foregoing Lorentz-Lorentz equation, which is in almost all cases close to the measured value. Accordingly, in the invention, the refractive index of a surface treatment agent uses a value obtained by the foregoing method.

On the other hand, a surface treatment agent is required to introduce a functional group capable of bonding to the particle surface. There are cited introduction techniques, as below but are not limited thereto.

A. Physical adsorption (secondary-reactive surfactant treatment),

B. Surface chemical species-employing reaction (covalent-bonding to a surface hydroxyl group),

C. Surface introduction of active species and its reaction (introduction of an active point such as a radical and graft polymerization, exposure to a high energy ray and grail polymerization),

D. Polymer coating (capsulation, plasma polymerization),

E. Deposition solidification (deposition of a sparingly soluble organic acid salt).

Further, specific examples are shown below.

### (1) Silane Coupling Agent:

There is employed a condensation reaction or a hydrogen bonding between a silanol group and a hydroxyl group on the particle surface. Specific examples of a silane coupling agent exhibiting a refractive index of not less than 1.5 include p-stryltrimethoxysilane, N-phenyl-3-aminopropyltrimethoxysilane, phenyltrichlorosilane, diphenyldichlorosilane, phenyltrimethoxysilane, diphenyldimethoxysilane, and diphenyldimethoxysilane. A coupling agent other than the foregoing ones detaches an alkoxyl group upon reaction with the particle surface, whereby the refractive index is substantially increased, therefore, even a coupling agent exhibiting a refractive index of less than 1.5 is also applicable to the present invention. Many of coupling agents exhibiting a refractive index of not less than 1.50 contain an aromatic ring or a heteroatom, but an adamantly group or its derivatives are effective for enhancement of the ref active index. For example, triadamantylchlorosilane, bi-adamantyltrimethoxysilane or the like is suitably usable.

It is preferred to provide a double-bonding functional group on the particle surface, thereby providing a bond between the resin and a particle, however, even if the number of double-bonding function groups on the particle surface is large, all of them cannot contribute to the reaction. The addition amount of a conventional coupling agent is referred to a minimum coverage area (m²/g). Referring to this value, the number of functional groups per unit area (number/nm²) is to an extent of 7-8 but the number of polymer molecule chains capable of being grafted onto the particle surface, for example, in the case of acryl, is supposed to be at most 2 line/nm², therefore, an addition amount of a double-bonding coupling agent may be less than that of, for example, a silane coupling agent containing an adamantyl group. Thus, the average refractive index of a surface treatment agent can be controlled to 1.50 or more.

### (2) Other Coupling Agents:

Titanate or aluminate coupling agents are also applicable. Some of commercially available coupling agents contain a straight alkyl group and the refractive index of them is not always more than 1.50, however, modification of their functional groups makes it feasible to exceed 1.50. There are also usable a zircoaluminate, chromate, borate, stagnate, isocyanate and the like. Further, a diketone-type coupling agent is also usable.

### (3) Surfactant and Others:

There are applicable an alcohol, a nonionic surfactant, an ionic surfactant, carboxylic acids, amines and the like.

### (4) Polymer Surface Treatment:

There is a technique of introducing an active species onto the particle surface by using a treatment agent of the foregoing (1)-(3), followed by providing a polymer layer on the surface through graft polymerization; or a technique of allowing a previously synthesized polymeric dispersant to be adsorbed onto the particle surface. Graft polymerization is preferable to form a strong polymer layer on the particle surface and it is specifically preferable to be grafted at a high density.

The refractive index of a surface treatment agent of not less than 1.50 can inhibit vitiation of capability of enhancing the refractive index by particles but, as described earlier, optical properties of particles are important not only in refractive index but also in wavelength dispersion. Although an enhancement of refractive index by introduction of an aromatic ring to a surface treatment agent is preferable, introduction of a functional group expected for a small wavelength dispersion (a large Abbe's number) is preferable from the viewpoint of wavelength dispersion control even if the refractive index is 1.50 or slightly more, such as an adamantly group.

### Curable Resin Compound

Next, there will be described a curable resin compound related to the invention (hereinafter, also denoted simply as curable resin).

One aspect of the invention, the optical composite material is formed of a curable resin and the foregoing inorganic particles. There is usable any curable resin which is capable of being cured upon exposure to actinic rays such as ultraviolet rays or an electron beam, or by a heating treatment; that is, such a resin is mixed with inorganic particles and then cured to form a transparent resin composition. Examples of such a resin include an epoxy resin, a vinyl ester resin, a silicone resin, an acryl resin, and an allyl ester resin. Such a curable resin may be an actinic ray-curable resin which is curable upon exposure to ultraviolet rays or an electron beam, or a thermally curable resin which is curable by a heating treatment. For example, such resins, as described below are preferable.

A silicone resin is a polymer having a backbone of a siloxane bonding (—Si—O—) in which silicon (Si) and oxygen (O) are alternately bonded.

There is usable a silicone resin comprised of a prescribed amount of a polyorganosiloxane resin (as described in, for example, JP 06-009937A).

Any heat-curable polyorganosiloxane resin which is capable of forming a three-dimensional network structure of a siloxane bond skeleton through sequential hydrolysis/dehydration condensation reaction is usable without any special limitation, which exhibits curability on heating at a high temperature over a long duration and the property of being hardly softened upon heating.

Such a polyorganosiloxane resin contains a constituent unit of the general formula (A) and may be any of a chain form, a cyclic form and a network form.

(R₁—R₂—SiO)ₙ Formula (A)

where R₁ and R₂, which may be the same or different, are each a monovalent hydrocarbon group which may be substituted or unsubstituted. Specifically, R₁ and R₂ include an alkyl group such as methyl, ethyl, propyl or butyl, an alkeny group such as vinyl or allyl, an aryl group such as phenyl or tolyl, a cycloalkyl group such as cyclohexyl or cyclooctyl, or a group in which a hydrogen atom attached to the individual group described above is substituted by a halogen atom, a cyano group, an amino group or the like, for example, chloromethyl, 3,3,3-trifluoropropyl, cyanomethyl, γ-aminopropyl, and N-(β-aminoethyl)-γ-aminopropyl. R₁ and R₂ may be a group selected from a hydroxyl group and an alkoxy group. In the formula (A), n is an integer of 50 or more.

A polyorganosiloxane is used through solution in a hydrocarbon solvent such as toluene, xylene, or a petroleum solvent, or a mixture of the foregoing solvent with a polar solvent. Different compositions may be blended within a range of being compatible with each other.

A production method of a polyorganosiloxane resin is not specifically limited and may employ any method known in the art. For instance, a polyorganosiloxane resin can be obtained by hydrolysis or alcoholysis of an organohalogenosilane or an its mixture. A polyorganosiloxane resin generally contains a hydrolysable group such as a silanol group or an alkoxy group, and these groups are contained in a content of 1 to 10% by mass in terms of an equivalent converted to a silanol group.

These reactions are usually carried out in the presence of a solvent capable of melting an organohalogenosilane. A block copolymer can also obtained by a method in which a linear polyorganosiloxane containing a hydroxy group, an alkoxy group or a halogen atom at the end of a molecular chain is co-hydrolyzed together with an organotrichlorosilane. The thus obtained polyorganosiloxane resin generally contains a residual HCl, and such a residual HCl content in the composition in the embodiments of the invention is preferably not more than 10 ppm in terms of storage stability, and more preferably not more than 1 ppm.

An epoxy resin can use an alicyclic epoxy resin such as 3,4-epoxycyclohexylmethyl-3′,4′-cyclohexylcarboxylate (WO 2004/031257, see also pamphlet), and a spiro ring-containing epoxy resin or a linear aliphatic epoxy resin are also usable.

There are usable a curable resin containing an adamantine backbone, such as 2-alkyl-2-adamantyl(meth)acrylate (JP 2002-193883A), 3,3′-dialkoxycarbonyl-1,1′-biadamantane (JP 2001-253835A), 11′-biadamatane compound (U.S. Pat. No. 3,342,880), tetraadamatane (JP 2006-169177A), a curable resin having an adamantine backbone containing no aromatic ring, such as 2-alkyl-2-hydroxyadamantane, 2-alkylene-or di-tert-butyl 1,3-adamantane-dicarboxylate (JP 2001-322950A), and bis(hydroxyphenyl)adamintanes or bis(glycidyloxyphenyl)adamantine (JP 11-035522A, JP 10-0130371A).

There are also preferably usable a bromine-containing (meth)acryl ester containing no aromatic ring (JP 2003-066201A), allyl(meth)acrylate (JP 05-0286896A), an allyl ester resin (JP 05-286896A, JP 2003-066201A), a copolymer compound of an acrylic acid ester and an epoxy group-containing, unsaturated compound (JP 2003-128725A), an acrylate compound (JP 2003-147027A), and an acryl ester compound (JP 2005-002064A).

To inhibit light scattering at the interface between a surface treatment layer and a resin, the difference in refractive index between such a curable resin and an organic material layer formed on the particle surface (in the usable wavelength region) is preferably not more than 0.2. In cases when a particle diameter including a surface treatment layer is small, it is not important to lower the refractive index difference. Voids in the interior of an optical composite material, generated due to particle coagulation or deteriorated adhesion between a particle and a resin, induce internal unevenness of refractive index, causing light scattering.

### Production Method of Optical Device

An organic or inorganic precursor (in an uncured state) of an optical composite material, as a raw material for an optical device of the invention is first produced in the production process of the optical device.

An organic or inorganic precursor of an optical composite material may be prepared in such a manner that a curable resin dissolved in a solvent and inorganic particles related to the invention are mixed and then the solvent is removed, or the inorganic particles are added to a monomer solution, followed by performing polymerization. Alternatively, a monomer may melt a partially polymerized oligomer or a low molecular weight polymer, followed by addition of inorganic particles thereto.

In the invention is preferred a method of adding the inorganic particles related to the invention, followed by performing polymerization. Specifically, it is preferred to mix a highly viscous solution of a monomer mixed with the inorganic particles, while cooling with shearing. In that case, it is important to control the viscosity so that the inorganic particles are optimally dispersed in the curable resin. Controlling the viscosity include controlling the particle size, surface state or addition amount of inorganic particles, or addition of a solvent or a viscosity controlling agent. The inorganic particles of the invention, which are structurally easily surface-modified, can achieve a most suitable kneading state.

When performing composition with shearing, the inorganic particles of the invention can be added in a powder form or in the state of being coagulated. Alternatively, the inorganic particles may be added in the state of being dispersed in liquid. When added in the state of being dispersed in liquid, it is preferred to perform degassing after being mixed.

When added in the state of being dispersed in a liquid, it is preferred disperse coagulated particles into primary particles in advance. Various dispersing machines are usable for dispersion and a bead mill is preferred. Beads include various kinds of materials, and ones with a small bead size is preferred and ones with a diameter of 0.001 to 0.5 mm is specifically preferred.

The inorganic particles related to the invention are featured in being added in the state of being previously surface-treated. A technique such as an integral blend is feasible, in which a surface treatment agent and inorganic particles are simultaneously added and composition with a curable resin is performed.

### Cross-linking Density of Optical Composite Material

The optical composite material of the invention exhibits a cross-linking density of not less than 0.50 mmol/cm³ and not more than 7.0 mmol/cm³.

The cross-linking density of an optical composite material, as defined in the invention can be determined by various methods. There is easily applicable, for example, a method in which E′ is determined from measurement of viscoelasticity and from variation is determined the cross-linking density. The number of cross-linking points can be calculated from the content of a cross-linkable monomer. For example, in the case when the specific gravity of a cured material of ethylene glycol dimethacrylate (molecular weight of 198) is 1.2, the molar number per cm² is to be:

12/(198×1000)=6.06 mmol

and assuming that 80% of double bonds are reacted and contribute to cross-linking, the cross-linking density is determined to be

6.06×0.8=4.85 mmol/cm³

The reaction factor of the double bonds can be determined by NMR or IR spectroscopy.

The cross-linking density defined in the invention is a value measured on the basis of the reaction factor of a cross-linking agent, determined from the quantity of a cross-linking agent added and NMR.

The cross-linking density relating to the invention can be controlled by the following methods.

### Control Method by Use of Polyfunctional Monomer:

The use of a monomer containing plural polymerizable functional groups in the molecule results in an increased cross-linking density. Specifically, a large number of cross-linking function groups results in an increased cross-linking density. In the case of acryl resin, for example, various monomers are usable, including a di-functional monomer such as ethylene glycol dimethacrylate, a ten-functional monomer such as pentaerythritol tetramethacrylate, and dipentaerythritol hexamethacrylate.

Control Method by Providing many Functional Groups on the Particle Surface:

The inorganic particle surface also acts as cross-linking points, so that providing many cross-linking points on the inorganic particle surface results in an increased cross-linking density.

### Control Method by Use of Cross-Linking Agent

In the case of an acryl resin, for example, not only extension of a double bonding chain but also the reaction of a sulfur compound proceeds. For example, the use of a cross-linking agent containing plural mercapto groups can increase the number of cross-linking points. A peroxide compound or the like is also applicable. Further, there are various kinds of cross-linking agents such as a polymeric cross-linking agent.

In the invention, the cross-linking density achieved by these methods is not less than 050 mmol/cm³ and not more than 7.0 mmol/cm³, and preferably not less than 0.70 mmol/cm³ and not more than 7.0 mmol/cm³. In a material having a sufficiently large cross-linking density, so-called Tg disappears, sensitivity to heat is lowered and heat resistance is enhanced.

It is also affected by an initiator amount, selection of the kind, reaction temperature, energy ray exposure state, oxygen and water content

### Saturated Water Absorption Amount

In the invention, the saturated water absorption amount of an optical composite material is preferably not more than 3.5% by mass under an atmosphere of 70° C. and 80% RH. A material of a relatively large saturated water absorption amount is greatly variable with change of atmosphere (temperature, humidity), leading to instability of optical properties.

The saturated water absorption amount defined in the present invention can be determined in accordance with following method. After an evaluation sample is allowed to stand in a dry oven of 85° C. for three days, a mass A in an absolute dry state is measured. Subsequently, after being allowed to stand in a high temperature, high humidity incubator of 70° C. and 80% RH for four weeks, a mass B thereof is measured. At that moment, it is confirmed from mass change that it has reached saturation. Subsequently, a saturated water absorption amount is determined in accordance with the following equation:

Saturated water absorption amount (% by mass)={(mass B−mass A)/(mass A)}×100

Control of saturated water absorption amount is important in the following three points:
(1) The saturated water absorption amount of a resin is lowered,
(2) The saturated water absorption amount of particles is lowered,
(3) The saturated water absorption amount of a surface treatment agent is lowered.

It is necessary to reduce the polarity of a resin to lower the water absorption amount of the resin. Accordingly, it is preferred to reduce oxygen-containing functional groups such as a hydroxyl group or an ester, various functional group exhibiting an acid or base property, sulfur or nitrogen. In the case of an acryl resin or an epoxy resin, a cross-linkable functional group often exhibits polarity, so that the number thereof is preferably as small as possible, as long as a necessary cross-linking density is achieved and it is also preferable to reduce the number of unsaturated functional groups.

In the invention, it is significant to reduce the saturated water absorption amount of inorganic particles. It is supposed that a particle of a 1.70 or more refractive index exhibits less voids or micro-pores in the interior of the particle, forming a crystal structure and therefore, water adsorbed onto the surface is related to the saturated water absorption amount. Water adsorbed onto the particle surface is supposed to be adsorbed to a polar functional group on the surface. In the case of a metal oxide, the polar functional group is mainly a hydroxyl group, and in the case of a particle composed of a salt such as a sulfate or carbonate, polarization of the surface, partial bias of composition and the like are cited as a polar functional group. Even in a nitride or sulfide particle, various polar functional groups are supposed but a hydroxyl group due to impurities can be a cause.

An effective technique to control these is supposed to be a treatment with an organic functional group or a treatment with an inorganic material.

It is thought that such a treatment with an inorganic material is employment of the reaction of a surface hydroxyl group of the foregoing surface treatment. It is specifically preferred to employ a silicone reactant, as typified by hexamethyldisilaxane but is not limited thereto and there are applicable various kinds of treatment agents such as organic fluorine compounds or hydrocarbon treatment agents.

Treatments with an inorganic material include a treatment with a silicone compound or fluorine. Examples of such a silicone compound include a monomethyl polysiloxane and a dimethyl polysiloxane. A silicone containing a SiH group, such as monomethyl siloxane is specifically preferred.

Treatments using fluorine include fluorination of the particle surface. A strong acid such as hydrofluoric acid strongly dissolves inorganic particles but if reacted with a small amount thereof, it becomes feasible to fluorinate only the uppermost surface. Alternatively, it is feasible that other fluorine-containing compounds (for example, ammonium fluoride) and inorganic particles are mixed and heated under appropriate conditions to introduce fluorine onto the particle surface, whereby the number of hydroxyl groups is reduced to achieve reduction of water absorption.

To inorganic particles having cationic surfaces, there may be added an anion such as 1,1,1-trifluoromethanesulfonamide which becomes a hydrophobic anion upon forming a salt, thereby leading to reduced water absorptivity.

### Other Additive to Optical Device

In addition to a curable resin and inorganic particles related to the invention, there may be incorporated various kinds of additives in accordance with intended usage when preparing an optical composite material or producing an optical device. Examples of such additives include stabilizers such as an antioxidant, a light stabilizer, a heat stabilizer, a weather-proofing agent, an ultraviolet absorbent and an infrared absorbent; a resin improver such as a lubricant agent or a plasticizer, a soft polymer, an anti-whitening agent such as a alcoholic compound; a colorant such as a dye or pigment; and an antistatic agent or a flame retardant. Such additives may be used alone or in combination.

### Antioxidant

Examples of an antioxidant applicable to the optical device of the present invention include a phenolic antioxidant, a phosphorus antioxidant and a sulfur antioxidant. Incorporation of such an antioxidant can prevent a coloring or strength lowering of a lens, due to oxidative deterioration at the time of molding of an optical resin material, without causing a lowering of transparency or heat resistance.

There are applicable commonly known phenolic antioxidants and examples thereof include 2-t-butyl-6-(3-t-butyl-2-hydroxy-5-methylbenzyl)-4-methlphenylacrylate and 2,4-di-t-amyl-6-[1-(3,5-di-t-amyl-2-2-hydroxyphenylmethyl]phenylacrylate, as described in JP63-179953A; an acryl compound such as octadecyl-3-(3,5-di-t-butyl4-hydroxyphenyl)propionate, as described in JP 01-168643A; an alkyl-substituted phenol compound such as 2,2′-methylene-bis(4-methyl-6-t-butylphenol), 1,1,3-tris(2-methyl-4-hydroxy-5-t-butylphenyl)butane, and 1,3,5-trimethyl-24,6-tris(3,5-di-t-butyl-4-hydroxybenzyl)benzene, tetrakis[methylene-3-(3′,5′-di-t-butyl-4′-hydroxyphenylpropionate)]methane, that is, pentaerythrimethyl-tetrakis[3-(3,5-di-t-butyl-4-hydroxyphenylpropionate)]; and a triazine group-containing phenol compound such as 6-(4-hydroxy-3,5-di-t-butylanilino)-2,4-bisoctylthio-1,3,5-triazine, and 2-octylthio-4,6-bis-(3,5-di-t-butyl-4-oxyanilino)1,3,5-triazine.

There are usable any phosphorus antioxidants which are usually used in general resin industries and specific examples thereof include monophosphite compounds such as triphenyl phosphite, diphenyl phosphite, phenyl diisodecyl phosphite, tris(nonylphenyl)phosphite, tris(dinonylphenyl)phosphite, tris(2,4-t-butylphenyl)phenyl phosphite, and 10-(3,5-dit-butyl-4-hydroxylbenzyl)-9,10-dihydro-9-oxa-10-phosphaphenthrene; and diphosphite compounds such as 4,4′-butylidene-bis(3-methyl-t-butylphenyl-di-tridecylphosphite) and 4,4′-isopropylidene-bis(phenyl-di-alkyl(C₁₂-C₁₅) phosphite. Of these, monophosphite compounds are preferred, and tris(nonylphenyl)phosphite, tris(dinonylphenyl)phosphite and tris(2,40di-t-butylphenyl)phosphite are specifically preferred.

Specific examples of a sulfur antioxidant include dilauryl 3,3′-thiodipropionate, dimyristyl 3,3′-thiodipropionate, distearyl dimyristyl 3,3′-thiodipropionate, laurylstearyl dimyristyl 3,3′-thiodipropionate, pentaerythritol-tetakis-(β-lauryl-thio-propionate) and 3,9-bis(2-dodecylthioethyl)-2,4,8,10-tetraoxaspiro[5,5]undecane.

In addition to the foregoing phenol, phosphorus and sulfur antioxidants, there are also usable an amine antioxidant such as a diphenylamine derivative, nickel or zinc thiocarbamate.

The foregoing antioxidants may be used alone or in combination and its addition amount can appropriately be chosen within a range not vitiating the object of the present invention, preferably from 0.001 to 20 parts by mass and more preferably from 0.01 to 10 parts by mass.

### Anti-Clouding Agent:

It is preferred to incorporate a compound exhibiting the lowest glass transition temperature of not more than 30° C., as an anti-clouding agent applicable to the optical device of the present invention. Thereby, milky-whitening of an optical device can be prevented without lowering characteristics such as optical transmittance, heat resistance, mechanical strength and the like, even when preserved under an environment of high temperature and high humidity.

### Light Stabilizer:

Light stabilizers (light keeping agents) are classified to a quencher and a radical scavenger. A benzophenone light stabilizer, a benzotriazole light stabilizer and a triazine light stabilizer are classified as a quencher, and a hindered amine light stabilizer is classified as a radical scavenger. In the invention, it is preferred to use a hindered amine light stabilizer (HALS) in terms of transparency and anti-coloring of an optical device. Its specific example can be chosen from a low molecular weight HALS, a medium molecular weight HALS and a high molecular weight HALS.

Specific examples of a low molecular weight HALS include LA-77 (made by Asahi Denka), Tinuvin 765 (made by Ciba Speciality Chemicals, hereinafter, also denoted simply as made by CSC), Tinuvin 440 (made by CSC), Tinuvin 144 (made by CSC), Hostavin N20 (made by Höchst Corp.); specific examples of a medium molecular weight HALS include LA-57 (made by Asahi Denka), LA-52 (made by Asahi Denka), LA-67 (made by Asahi Denka) and LA-62 (made by Asahi Denka); and specific examples of a high molecular weight HALS include LA-68 (made by Asahi Denka), Hostavin N30 (made by Höchst Corp.), Chimassorb 944 (made by CSC), Tinuvin 622 (made by CSC), Cyasorb UV-3346 (made by Cytec), Cyasorb UV-3529 (made by Cytec) and Uvasil 299 (made by GLC). Specifically, a low or medium molecular weight HALS is preferably employed for a molded optical resin material (optical device) and a high molecular weight HALS is preferably employed for a film-formed optical resin material.

HALS is also used preferably in combination with a benzotriazole light stabilizer. Examples thereof include Adecastab LA-32,LA-36 and LA-3 (made by Asahi Denka), and Tinuvin 326, Tinuvin 571, Tinuvin 234, and Tinuvin 1130 (made by CNS).

HALS is also used preferably in combination with various kinds of antioxidants. The combination of HALS and an antioxidant is not specifically limited, and a combination with a phenol, phosphorus or sulfur antioxidant is applicable and a combination with phenol and phosphorus antioxidants is preferred.

### Other Additive:

In addition to the foregoing antioxidants and light stabilizers, additives applicable to the optical device of the invention include a stabilizer such as heat stabilizer, a weather resistant stabilizer or a near-infrared absorber; a resin modifier such as a lubricant or plasticizer; an anti-clouding agent such as soft polymer or an alcoholic compound; and an antistatic agent or a flame retardant. These may be used alone or in combination and the addition amount thereof is appropriately chosen within a range not vitiating the effect of the invention.

Application Field of Optical device

The optical device of the invention can be obtained by the methods described above and are applicable to optical parts, as described below.

Examples of an optical lens or optical prism include an imaging lens for a camera; lens for a microscope, an endoscope or a telescope; light transmissive lens such as a eyeglass lens; a pickup lens of an optical disk of CD, CD-ROM, WORM (write-once light disk) MO (re-writable light disk, magneto-optical disk), MD (mini-disk) and DVD (digital video disk); laser scanning lens such as fθ lens or a sensor lens; and a prism lens used as a finder of a camera.

Usage for optical disk include CD, CD-ROM, WORM (write-once light disk) MO (re-writable light disk, magneto-optical disk), MD (mini-disk) and DVD (digital video disk). Other optical usage include a light-introducing plate for a liquid crystal display; an optical film such as a polarizing film, a phase difference film or a light diffusion film; a light diffusion plate; a photocard; and a liquid crystal display device substrate.

### Examples

The present invention will be further described with reference to examples but the invention is not restricted to these. In examples, “part(s)” and “%” represent “part(s) by mass” and “% by mass” unless otherwise noted.

### Preparation of Inorganic Particles

### Preparation of Zirconia Particle 1:

To a zirconium salt solution of 2600 g of zirconium oxychloride octahydride dissolved in 40 L of pure water was added diluted ammonia water of 340 g of 28% ammonium water dissolved in 20 L of pure water to prepare a zirconia precursor slurry.

Subsequently, to the zirconia precursor slurry was added an aqueous sodium sulfate solution of 400 g of sodium sulfate dissolved in 5 L pure water, while stirring.

Then, using a drying machine, this mixture was dried at 120° C. in the atmosphere over 24 hrs to obtain a solid material.

Subsequently, the solid material was ground in an automatic mortar and burned at 500° C. over one hour in the atmosphere using an electric furnace. The thus burned material was fed into pure water and stored to form a slurry. Then, the slurry was washed by using a centrifugal separator to remove the added sodium sulfate and dried in a drying machine to prepare zirconia particles 1. As a result of TEM observation, it was proved that the volume average particle diameter was 5 nm. From XRD, it was also proved that the particles were crystalline ZrO₂.

### Preparation of Zirconia Particle 2:

Zirconia particles RC-100, made by Daiichi Kigenso Co. were used as zirconia particles 2. It was proved that the volume average particle size of the zirconia particles 2 was 20 nm and the refractive index was 220.

### Preparation of Alumina Particle 1:

In 500 g of water containing 1 g of ammonia was dispersed 10 g of alumina (TM-300, made by Taimei Kagaku Co.). Using an ultra-apex mill and 0.03 mm zirconiz beads as a dispersing machine, dispersion was conducted at a liquid temperature of 20° C. over 2 hrs. The thus obtained particles were dried in a drying machine, observed by TEM and proved to be alumina particles with less aggregation, exhibiting a volume average particle size of 7 nm and a refractive index of 1.69.

### Preparation of Silicon Oxide Particle 1:

There was used Organosilica sol PL-1 (toluene dispersion, made by Fuso Kagaku Kogyo Co.) exhibiting a volume average particle size of 15 nm and a refractive index of 1.46.

### Preparation of Titania Particle 1:

The inside of a 300 ml three-necked flask was washed with concentrated hydrochloric acid. Then, 100 ml of desalted water was added to the flask and the atmosphere was replaced by nitrogen. Thereto was added 4 ml of concentrated hydrochloric acid and the temperature was maintained at not more than 10° C. in an ice bath. Further thereto, 4 ml of TiCl₄ was dropwise added at a rate of 3 ml/min by using a syringe. The thus obtained solution was stirred at a temperature of not more than 10° C. for 15 min., transferred to an oil bath and stirred at 60° C. for 1 hr. The obtained titanium oxide solution was distilled in vacuo by using a vacuum pump to remove water. To the obtained white powder was added a tetrahydrofuran/ethanol (1:1 mixture) solution and exposed to ultrasonic waves by using an ultrasonic washing machine, whereby a transparent 10% by mass titanium oxide particle solution A was obtained. From measurement of XRD (powder X-ray analysis), it was proved that the volume average particle size of titanium oxide was 4 nm.

The obtained sol was subjected to a supercritical hydrothermal reaction under conditions of a reaction temperature of 500° C., a reaction pressure of 30 MPa and a reaction time of 30 msec to achieve enhancement of crystallinity. From measurement of the refractive index of the dispersion, the refractive index of the particles was calculated to be 2.61.

### Preparation of ZnTe Particle:

Into an eggplant type flask was weighed 517 mg of tellurium and 1.186 ml of tributylphosphine (hereinafter, also denoted simply as TBP) and 8.51 ml of dioctylamine (hereinafter, also denoted simply as DOA) were added thereto through a syringe operation. Stirring continued until the tellurium was completely dissolved to form a colorless transparent solution. The obtained tellurium solution was stored in a refrigerator until immediately before being used.

The inside of a three-necked flask fitted with a condenser, a thermometer and a three-way stop-cock, and 30 mg of zinc oxide (ZnO), and 456 mg of stearic acid were introduced thereto and heated at 150° C. so that the ZnO was completely dissolved. After the reaction vessel was cooled to a temperature near room temperature, 7.76 g of trioctylphosphine oxide (hereinafter, also denoted simply as TOPO) and 7.76 g of hexadecylamine (hereinafter, also denoted simply as HIDA) were added and the temperature was raised to 300° C. to obtain a colorless transparent solution. Subsequently, 1 ml of the foregoing tellurium solution (Zn/Te=1/1) was added through a syringe operation to initiate the reaction. The reaction was terminated 7 minutes after the start of the reaction, and a small amount of the reaction solution was taken out and fine particles separated by centrifugal separation were observed by TEM and it was confirmed that micro-crystals having a volume average particle size of approximately 3 nm were obtained. Calculating backward from the refractive index of the dispersion, it was proved that the refractive index of the ZnTe particles was 2.90. Repeating this operation, there was obtained the required amount of ZnTe particles.

### Preparation of Surface Treatment Agent

A surface treatment agent containing an organic functional group to be bonded to the particle surface was prepared as below.

### Surface Treatment Agent 1 (Carbazole Group-Containing Surface Treatment Agent):

N-vinylcarbazole was gradually added to a benzene solution (10 g) containing 3-mercaptopropyltrimethoxysilane (9.8 g) and azobisisobutyronitrile (4.1 g), and after being bubbled with nitrogen, a reaction was performed over 20 hrs, while being refluxed. The obtained solution were filtered to remove any solvent from precipitates to obtain a surface treatment agent 1 of a carbazole group-containing surface treatment agent. The refractive index of the surface treatment agent 1 was calculated to be 1.68 from the Lorentz-Lorentz equation.

### Surface Treatment Agent 2 (Phenyl Group-Containing Surface Treatment Agent):

Phenyltrimethoxysilane (made by Shinetsu Kagaku Co., Ltd.) was used as a surface treatment agent 2 (phenyl group-containing surface treatment agent). The refractive index of the surface treatment agent 2 was calculated to be 1.59, from the Lorentz-Lorentz equation.

### Surface Treatment Agent 3 (Adamantyl Group-Containing Surface Treatment Agent):

To 200 g of dehydrated pyridine solution containing 7 g of dehydrated methanol was gradually dropwise added under room temperature. Alter being stirred for one hour, ₜhe reaction mixture was refluxed, while heating over 10 hours. After pyridine and methanol were distilled out from the obtained solution, washing was conducted to obtain an adamanty group-containing surface treatment agent of 1-adamantyltrimethoxysilane (surface treatment agent 3). The refractive index of the surface treatment agent 3 was calculated to be 1.52 from the Lorentz-Lorentz equation.

### Surface Treatment Agent 4 (Long Chain Alkyl Group-Containing Surface Treatment Agent):

Octyltrimethoxysilane (made by Shinetsu Kagaku Co., Ltd,) was used as a surface treatment agent 4 (long chain group-containing surface treatment agent). The refractive index of the surface treatment agent 4 was calculated to be 1.48 from the Lorentz-Lorentz equation.

### Surface Treatment Agent 5 (Fluorine-Containing Anionic Surface Treatment Agent):

Trifluoromethylsulfonylamide (H-TFSI, made by Morita Kagalcu Co., Ltd.) was used as a surface treatment agent 5. The refractive index of the surface treatment agent 5 was calculated to be 1.52 from the Lorentz-Lorentz equation.

### Preparation of Surface-Treated Inorganic Particle

### Preparation of Surface-Treated Inorganic Particle 1 (Surface Treatment of Zirconia Particle):

To 100 ml of toluene containing 2 g of the surface treatment agent 1 (carbazole group-containing surface treatment agent) and 0.1 g of methacryloxypropyltrimethoxysilane was added 10 g of the foregoing zirconia particle 1 and heated to 100° C., while dispersing by using 0.03 mm zirconia beads under nitrogen to obtain a homogeneous dispersion. Thereafter, the dispersion was refluxed under nitrogen for 5 hours with heating to obtain a toluene dispersion of surface-treated zirconia particles. Further, particles were sedimented from the obtained dispersion through centrifugal separation to remove unreacted materials in the supernatant and dried in vacuo at 50° C. for 24 hours to prepare a surface-treated inorganic particle 1 in which zirconia particles were surface-treated with a carbazole group-containing surface treatment agent

### Preparation of Surface-Treated Inorganic Particles 2-4 (Surface Treatment of Zirconia Particle):

Surface-treated inorganic particles 2-4 were each prepared in the same manner as the preparation of the surface-treated inorganic particle 1, except that the surface treat agent 1 was replaced by each of surface treatment agents 2-4.

### Preparation of Surface-Treated Inorganic Particle 5 (Surface Treatment of Zirconia Particle):

Surface-treated inorganic particle 5 was prepared in the same manner as the preparation of the surface-treated inorganic particle 1, except that there were used zirconia particles in which the zirconia particle 1 was treated with a 100 g aqueous solution containing 0.1 g of trifluoromethylsulfonylamide (surface treatment agent 5) in advance and dried.

### Preparation of Surface-Treated Inorganic Particle 6 (Surface Treatment of Zirconia Particle):

Surface-treated inorganic particle 6 was prepared in the same manner as the preparation of the surface-treated inorganic particle 1, except that the zirconia particle 1 was replaced by the zirconia particle 2 (zirconia particles RC-100, made by Daiichi Kigenso Co.) and the addition amount of the surface treatment agent 3 was changed to 0.5 g.

### Preparation of Surface-Treated Inorganic Particle 7 (Surface Treatment of Zirconia Particle):

To 100 ml of methyl isobutyl ketone containing 2 g of 1-adamantane carboxylic acid and 0.1 g of methacryloxypropyl-trimethoxysilane was added 10 g of the foregoing zirconia particle 1 and heated to 100° C. with stirring by using 0.03 mm zirconia particles to obtain a homogeneous dispersion. Thereafter, the dispersion was refluxed under nitrogen for 5 hours with heating to obtain a toluene dispersion of surface-treated zirconia particles. Further, the particles were sedimented from the obtained dispersion through centrifugal separation to remove unreacted materials in the supernatant and dried in vacuo at 50° C. for 24 hours to prepare a surface-treated inorganic particle 7.

### Preparation of Surface-Treated Inorganic Particle 8 (Surface Treatment of Alumina Particle):

To a toluene solution containing 1.4 g of the surface treatment agent 3 and 0.1 g of methacryloxypropyltrimethoxysilane was added 6.7 g of the foregoing alumina particle 1 and heated to 100° C. with stirring by using 0.03 mm zirconia particles to obtain a homogeneous dispersion. Thereafter, the dispersion was refluxed under nitrogen for 5 hours with heating to obtain a toluene dispersion of surface-treated alumina particles. Further, the particles were sedimented from the obtained dispersion through centrifugal separation to remove unreacted materials in the supernatant and dried in vacuo at 50° C. for 24 hours to prepare a surface-treated inorganic particle 8 of a surface-treated alumina powder.

### Preparation of Surface-Treated Inorganic Particle 9 (Surface Treatment of Alumina Particle):

Surface-treated inorganic particle 9 was prepared in the same manner as the preparation of the foregoing surface-treated inorganic particle 8, except that there were used alumina particles in which the alumina particle 1 was treated with a 100 g aqueous solution containing 0.1 g of trifluoromethylsulfonylamide (surface treatment agent 5) in advance and dried.

### Preparation of Surface-Treated Inorganic Particle 10 (Surface Treatment of Silica Particle):

To 100 ml of organosilica sol containing 3.4 g of silica (PL-1, toluene dispersion, made by Fuso Kagaku Kogyo Co.) were added 2 g of the surface treatment agent 3 and 0.1 g of methacryloxypropyl-trimethoxysilane was refluxed under nitrogen for 5 hours with heating to obtain a toluene dispersion of surface-treated silica particles. Further, the particles were sedimented from the obtained dispersion through centrifugal separation to remove unreacted materials in the supernatant and dried in vacuo at 50° C. for 24 hours to prepare a surface-treated inorganic particle 10.

### Preparation of Surface-Treated Inorganic Particle 11 (Surface Treatment of Titania Particle):

To a toluene solution containing 1.4 g of the surface treatment agent 3 and 0.1 g of methacryloxypropyltrimethoxysilane was added 3.3 g of the foregoing titania particle 1 and heated to 100° C. with stirring by using 0.03 mm zirconia particles to obtain a homogeneous dispersion. Thereafter, the dispersion was refluxed under nitrogen for 5 hours with heating to obtain a toluene dispersion of surface-treated titania particles. Further, the particles were sedimented from the obtained dispersion through centrifugal separation to remove unreacted materials in the supernatant and dried in vacuo at 50° C. for 24 hours to prepare a surface-treated inorganic particle 11 of a surface-treated titania powder.

### Preparation of Surface-Treated Inorganic Particle 12 (Surface Treatment of ZnTe Particle):

To a toluene solution containing 1.3 g of the surface treatment agent 3 and 0.1 g of methacryloxypropyltrimethoxysilane was added 8.1 g of the foregoing ZnTe particle 1 and heated to 50° C. with stirring by using 0.03 mm zirconia particles to obtain a homogeneous dispersion. Thereafter, the dispersion was rained under nitrogen for 5 hours with heating to obtain a toluene dispersion of surface-treated ZnTe particle& Further, the particles were sedimented from the obtained dispersion through centrifugal separation to remove unreacted materials in the supernatant and dried in vacuo at 50° C. for 24 hours to prepare a surface-treated inorganic particle 12 of a surface-treated ZnTe powder.

The details of the individual surface treatment agents represented by designations in Table 1 are as follows.

A: n-vinyl carbazole

B: phenyltrimethoxysilane

C: 1-adamantyltrichlorosilane

D: octyltrimethoxysilane

E: trifluoromethylsulfonylamide

F: 1-adamantane carboxylic acid

G: methacrylic acid

### Preparation of Optical Device (Evaluation Sample)

### Preparation of Optical Devices 1-6:

A curable resin composed of 5 g of adamantylmethyl methacrylate, 0.3 g of trimethylolpropane triacrylate, 0.1 g of dibenzoyl peroxide was mixed with 6.2 g of each the foregoing surface-treated inorganic particles 1-6, flowed between two fixed glass plates so that the thickness was 2 mm and cured at 130° C. for 10 minutes to prepare optical devices 1-6.

### Preparation of Optical Device 7-9:

Optical devices 7-9 were each prepared in the same manner as the foregoing optical device 3, except that the amount of trimethylolpropane triacrylate was changed to 0.15 g, 0.5 g and 023 g, respectively.

### Preparation of Optical Device 10:

Optical device 10 was prepared in the same manner as the optical device 3, except that the surface-treated inorganic particle 3 was replaced by the surface-treated inorganic particle 7.

### Preparation of Optical Device 11:

A curable resin composed of 5 g of adamantylmethyl methacrylate, 0.3 g of trimethylolpropane triacrylate, 0.1 g of dibenzoyl peroxide was mixed with 4.1 g of the foregoing surface-treated inorganic particle 8 (surface-treated alumina particles), flowed between two fixed glass plates so that the thickness was 2 min and cured at 130° C. for 10 minutes to prepare optical device 11.

### Preparation of Optical Device 12:

Optical device 12 was prepared in the same manner as the optical device 11, except that the surface-treated inorganic particle 8 was replaced by the surface-treated inorganic particle 9.

### Preparation of Optical Device 13:

Optical device 13 was prepared in the same manner as the optical device 3, except that the surface-treated inorganic particle 3 was replaced by the surface-treated inorganic particle 10.

### Preparation of Optical Device 14:

A curable resin composed of 5 g of adamantylmethyl methacrylate, 0.3 g of trimethylolpropane triacrylate, 0.1 g of dibenzoyl peroxide was mixed with 4.8 g of the foregoing surface-treated inorganic particle 11, flowed between two fixed glass plates so that the thickness was 2 mm and cured at 130° C. for 10 minutes to prepare optical device 14.

### Preparation of Optical Device 15:

A curable resin composed of 5 g of adamantylmethyl methacrylate, 0.3 g of trimethylolpropane triacrylate, a 1 g of dibenzoyl peroxide was mixed with 6.8 g of the foregoing surface-treated inorganic particle 12, flowed between two fixed glass plates so that the thickness was 2 mm and cured at 130° C. for 10 minutes to prepare optical device 15.

### Determination of Curing Density of Optical Device:

The curing density of each of the prepared optical devices was calculated based on the amount of an added cross-linking agent and the reaction factor of the cross-linking agent, determined from NMR, and obtained results are shown in Table 1.

TABLE 1

| | Surface-treated Inorganic Particle | | | | | | | | | | | | |
|---|---|---|---|---|---|---|---|---|---|---|---|---|---|
| | | Inorganic Particle | | | | Surface Treatment Agent | | | Cured Resin | | | | |
| | | | Average | | Refractive | | | Refractive | | | Refractive | | |
| | | | Particle | Volume | Index | | Volume | Index | | Volume | Index | Cross- | |
| Display | | | Diameter | Fraction | (measured | | Fraction | (calculated | | Fraction | (measured | linking | |
| No. | No. | Kind | (nm) | (vol. %) | value) | Kind | (vol. %) | value) | Kind | (vol. %) | value) | density *2 | Remark |
| 1 | 1 | zirconia particle 1 | 5 | 20 | 2.20 | A | 20 | 1.68 | *1 | 60 | 1.52 | 0.8 | Inv. |
| 2 | 2 | zirconia particle 1 | 5 | 20 | 2.20 | B | 20 | 1.59 | *1 | 60 | 1.52 | 0.8 | Inv. |
| 3 | 3 | zirconia particle 1 | 5 | 20 | 2.20 | C | 20 | 1.52 | *1 | 60 | 1.52 | 0.8 | Inv. |
| 4 | 4 | zirconia particle 1 | 5 | 20 | 2.20 | D | 20 | 1.48 | *1 | 60 | 1.52 | 0.8 | Comp. |
| 5 | 5 | zirconia particle 1 | 5 | 20 | 2.20 | C + E | 20 | 1.52 | *1 | 60 | 1.52 | 0.8 | Inv. |
| 6 | 6 | zirconia particle 2 | 20 | 20 | 2.20 | C | 5 | 1.52 | *1 | 75 | 1.52 | 0.8 | Comp. |
| 7 | 3 | zirconia particle 1 | 5 | 20 | 2.20 | C | 20 | 1.52 | *1 | 60 | 1.52 | 0.4 | Comp. |
| 8 | 3 | zirconia particle 1 | 5 | 20 | 2.20 | C | 20 | 1.52 | *1 | 60 | 1.52 | 1.2 | Inv. |
| 9 | 3 | zirconia particle 1 | 5 | 20 | 2.20 | C | 20 | 1.52 | *1 | 60 | 1.52 | 0.8 | Inv. |
| 10 | 7 | zirconia particle 1 | 5 | 20 | 2.20 | F | 20 | 1.52 | *1 | 60 | 1.52 | 0.8 | Inv. |
| 11 | 8 | alumina particle 1 | 7 | 20 | 1.69 | C | 14 | 1.52 | *1 | 66 | 1.52 | 0.8 | Inv. |
| 12 | 9 | alumina particle 1 | 7 | 20 | 1.69 | C + E | 14 | 1.52 | *1 | 66 | 1.52 | 0.8 | Inv. |
| 13 | 10 | silicon oxide | 15 | 20 | 1.46 | C | 7 | 1.52 | *1 | 73 | 1.52 | 0.8 | Inv. |
| | | particle 1 | | | | | | | | | | | |
| 14 | 11 | titania particle 1 | 4 | 20 | 2.61 | C | 25 | 1.52 | *1 | 55 | 1.52 | 0.8 | Inv. |
| 15 | 12 | ZnTe particle 1 | 3 | 20 | 2.90 | C + G | 25 | 1.51 | *1 | 55 | 1.52 | 0.8 | Inv. |

*1 adamantylmethyl methacrylate trimethylolpropane triacrylate
*2 mmol/cm³

### Evaluation of Optical Device

The thus obtained evaluation samples were measured and evaluated in accordance with the methods described below.

### Evaluation of Transparency (Measurement of Spectral Transmittance):

Using TURBIDITY METER T-2600 DA, MADE BY Tokyo Denshoku Co., Ltd., spectral transmittance (T₁) at 500 nm of each sample was measured in accordance with ASTM D-1003.

### Measurement of Refractive Index:

A refractive index under an environment of 23° C. and 55% RH was measured using a double refractometer.

### Measurement of Saturated Water Absorption Amount and Δnd

After being allowed to stand in a drying oven of 85° C. for three days, evaluation samples were each measured with respect to mass (denoted as mass A) in an absolute dry state. Subsequently, after being allowed to stand in a hydrothermostat of 70° C. and 80% RH for four weeks, each sample was measured with respect to mass (denoted mass B). In that case, saturation was confamed from change in mass. Then, a saturated water absorption amount (mass%) was determined according to the following equation:

Saturated water absorption amount (%)=[((mass B)−(mass A)}/(mass A)]×100

Subsequently, the refractive index before and after being allowed to stand in a hydrothermostat of 70° C. and 80% RH in a manner similar to the foregoing was measured using an automatic refractometer KPR-200, made by Kalnew Kogaku Kogyo) and the variation width (Δnd) of the refractive index between before and after a water absorption test was determined from the difference in refractive index.

### Measurement of Linear Expansion Coefficient:

Each sample was measured with respect to linear expansion coefficient (CTM, ppm) when varying the temperature from 40° C. to 60° C. There was used a measurement apparatus, TMA/SS6100, made by SII Nanotechnology Co.

TABLE 2

| | Measurement and Evaluation Result | | | | | |
|---|---|---|---|---|---|---|
| | | Refractive | | Saturated Water | | |
| Display | | Index | | Absorption | | |
| Device | Transmittance | (measured | CTE | Amount (mass | | |
| No. | (%) | value) | (ppm) | %) | Δnd | Remark |
| 1 | 85 | 1.688 | 45 | 2.9 | 0.00957 | Inv. |
| 2 | 88 | 1.670 | 46 | 2.2 | 0.00726 | Inv. |
| 3 | 89 | 1.656 | 44 | 2.2 | 0.00726 | Inv. |
| 4 | 89 | 1.648 | 58 | 2.3 | 0.00759 | Comp. |
| 5 | 89 | 1.660 | 44 | 1.0 | 0.00330 | Inv. |
| 6 | 14 | 1.656 | 42 | 1.6 | 0.00528 | Comp. |
| 7 | 90 | 1.656 | 61 | 2.4 | 0.00792 | Comp. |
| 8 | 85 | 1.656 | 41 | 2.4 | 0.00792 | Inv. |
| 9 | 88 | 1.656 | 49 | 2.4 | 0.00792 | Inv. |
| 10 | 89 | 1.656 | 47 | 4.8 | 0.01584 | Inv. |
| 11 | 87 | 1.554 | 41 | 3.6 | 0.01188 | Inv. |
| 12 | 91 | 1.554 | 41 | 0.9 | 0.00297 | Inv. |
| 13 | 89 | 1.508 | 41 | 1.3 | 0.00429 | Inv. |
| 14 | 79 | 1.740 | 48 | 3.3 | 0.01003 | Inv. |
| 15 | 65 | 1.782 | 51 | 3.9 | 0.01003 | Inv. |

As is apparent from the results shown in Table 2, it was proved that a display device formed of the optical composite material of the invention exhibited high transparency, superior heat resistance and also is less in linear expansion, as compared to comparative examples, and therefore was extremely effective as an optical device forming material.

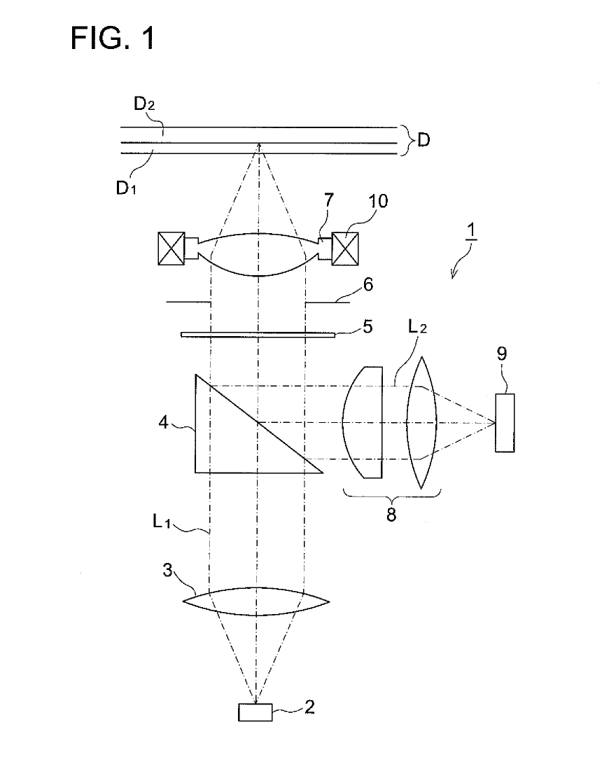

Further, in preparation of the foregoing samples for evaluation, a plastic lens (optical device) composed of the constitution shown in FIG. 1 was prepared by using a metal mold and evaluated with respect to various optical characteristics as a lens. As a result, it was confirmed that the optical device of the invention provided with excellent optical characteristics, as lens characteristics.

1. An optical composite material comprising a curable resin compound and inorganic particles having a volume average diameter of not less than 3.0 nm and not more than 15 nm and having been treated with a surface treatment agent exhibiting an average refractive index of not less than 1.50 and not more than 1.70, and the composite material exhibiting a cross-linking density of not less than 0.50 mmol/cm³ and not more than 7.0 mmol/cm³.

2. The optical composite material as claimed in claim 1, wherein the composite material exhibits not more than 3.5% by mass of a saturated water absorption amount at a temperature of 70° C. and a relative humidity of 80%.

3. The optical composite material as claimed in claim 1, wherein the inorganic particles exhibit a refractive index (nd) of not less than 1.50 and not more than 2.80.

4. The optical composite material as claimed in claim 1, wherein the surface treatment agent contains an adamantyl group.

5. The optical composite material as claimed in claim 1, wherein the curable resin compound contains an adamantyl group.

6. An optical device by use of an optical composite material, as claimed in claim 1.

7. A production method of an optical composite material, the method comprising the steps of:
subjecting inorganic particles to a surface treatment with a surface treatment agent, and
curing a mixture comprising the surface treated inorganic particles and a curable resin compound to produce the optical composite material,
wherein the composite material exhibits a cross-linking density of not less than 0.50 mmol/cm³ and not more than 7.0 mmol/cm³, and inorganic particles having a volume average diameter of not less than 3.0 nm and not more than 15 nm and the surface treatment agent exhibiting an average refractive index of not less than 1.50 and not more than 1.70.

8. The production method as claimed in claim 7, wherein the composite material exhibits not more than 3.5% by mass of a saturated water absorption amount at a temperature of 70° C. and a relative humidity of 80%.

9. The production method as claimed in claim 7, wherein the inorganic particles exhibit a refractive index (nd) of not less than 1.50 and not more than 2.80.

10. The production method as claimed in claim 7, wherein the surface treatment agent contains an adamantyl group.

11. The production method as claimed in claim 7, wherein the curable resin compound contains an adamantyl group.
